(19) United States
(12) Patent Application Publication
(10) Pub. No.: US 2024/0362939 A1
(43) Pub. Date: Oct. 31, 2024

(54) METHOD AND SYSTEM OF EXTRACTING NON-SEMANTIC ENTITIES

(71) Applicant: L&T TECHNOLOGY SERVICES LIMITED, Chennai (IN)

(72) Inventors: KALAKONDA KRISHNA VAMSHI, Hyderabad (IN); RAJESH RAJ, Bengaluru (IN); MADHUSUDAN SINGH, Bangalore (IN)

(21) Appl. No.: 18/544,485

(22) Filed: Dec. 19, 2023

(30) Foreign Application Priority Data
Apr. 27, 2023 (IN) 202341030420

(51) Int. Cl. G06V 30/186; G06F 40/279; G06F 40/40

(52) U.S. Cl. CPC G06V 30/186; G06F 40/279; G06F 40/40

(57) ABSTRACT

A method and system of extracting one or more non-semantic entities in a document image including data entities is disclosed. The methodology includes extraction, by a processor, of row entities and corresponding row location based on a text extraction technique from the document image. The row entities are split into split-row entities based on a splitting rule. Semantic entities are determined from alphabetic entities using semantic recognition technique. The non-semantic entities are determined as split-row entities other than semantic entities. Feature values of each feature type for each of the non-semantic entities is determined. The processor further determines a first probability output for non-semantic entities and a second probability output for semantic entities surrounding the non-semantic entities. The system further labels each of the non-semantic entities based on determination of a highest probability value from a sum of the first probability output and the second probability output.

### TECHNICAL FIELD

This disclosure relates generally to natural language processing and more particularly to a system and a method for extracting non-semantic entities from a document.

### BACKGROUND

Textual information can be extracted from data files such as PDF files, books, business cards, and the like using optical character recognition (OCR) techniques. The existing OCR text extraction method depends on identifying the text and its correctness based on pre-defined dictionaries. However, documents often include text which is not defined or present in any dictionary, such text may be referred to as non-semantic text. Therefore, the correct extraction of non-semantic text from documents becomes very challenging. The conventional processes include identifying aliases and forming templates from the text data for future extraction using OCR techniques, however, such processes require a lot of manual effort.

Therefore, there exists a requirement of a model which can easily extract the non-semantic text using OCR techniques and derive inferences without using templates.

### SUMMARY OF THE INVENTION

In an embodiment, a method for extracting non-semantic entities in a document image is disclosed. The method includes receiving, by a processor, the document image comprising a plurality of data entities. The method further includes extracting one or more row entities from the plurality of data entities for each row of the document image and a corresponding row location based on a text extraction technique from the document image. In an embodiment, the one or more row entities may include the one or more non-semantic entities and/or one or more semantic entities. In an embodiment, the one or more non-semantic entities may include a plurality of numeric characters or a combination of a plurality of numeric characters, a plurality of special characters, and a plurality of alphabetic characters. The method further includes for each of the rows of the document, splitting the one or more row entities into one or more split-row entities based on a predefined splitting rule. Further, for each of the rows of the document, one or more alphabetic entities and/or one or more numeric entities from the one or more split-row entities may be extracted based on detection of only alphabetic characters or only numeric characters respectively in each of the one or more row entities. The method includes extracting one or more semantic entities from the one or more alphabetic entities based on a semantic recognition technique and extracting non-semantic entities as the split-row entities other than the semantic entities. The method further includes determining a plurality of feature values corresponding to each of a plurality of feature types for each of the non-semantic entities. The method includes determining a first probability output for each of a plurality of labels for each of the one or more non-semantic entities based on the plurality of feature values using a first prediction technique. In an embodiment, the first prediction technique may be trained based on the first training data corresponding to a plurality of predefined non-semantic entities labeled based on the plurality of labels and the corresponding plurality of feature values. Further, the processor may determine a second probability output for each of the plurality of labels for each of the one or more semantic entities surrounding each of the one or more non-semantic entities using a second prediction technique. In an embodiment, the second prediction technique may be trained based on second training data including a list of surrounding unigram semantic entities, bigrams semantic entities and trigram semantic entities corresponding to the plurality of pre-defined non-semantic entities. The processor may label each of the one or more non-semantic entities based on the determination of the highest probability value from a sum of the first probability output and the second probability output for each of the plurality of labels.

In another embodiment, a system for extracting one or more non-semantic entities in a document image comprising one or more processors and a memory is disclosed. The memory may store a plurality of processor-executable instructions which upon execution causes the one or more processors to receive the document image comprising a plurality of data entities. The processor may further extract one or more row entities from the plurality of data entities for each row of the document image and a corresponding row location based on a text extraction technique from the document image. In an embodiment, the one or more row entities may include the one or more non-semantic entities and/or one or more semantic entities. In an embodiment, the one or more non-semantic entities may include a plurality of numeric characters or a combination of a plurality of numeric characters, a plurality of special characters, and a plurality of alphabetic characters. The processor may, for each of the rows of the document, split the one or more row entities into one or more split-row entities based on a predefined splitting rule. Further, for each of the rows of the document, one or more alphabetic entities and/or one or more numeric entities from the one or more split-row entities may be extracted based on detection of only alphabetic characters or only numeric characters respectively in each of the one or more row entities. The processor may extract one or more semantic entities from the one or more alphabetic entities based on a semantic recognition technique and extract non-semantic entity as split-row entities other than the semantic entities. The processor may further determine a plurality of feature values corresponding to each of a plurality of feature types for each of the non-semantic entities. The processor may further determine a first probability output for each of a plurality of labels for each of the one or more non-semantic entities based on the plurality of feature values using a first prediction technique. In an embodiment, the first prediction technique may be trained based on first training data corresponding to a plurality of predefined non-semantic entities labeled based on the plurality of labels and the corresponding plurality of feature values. Further, the processor may determine a second probability output for each of the plurality of labels for each of the one or more semantic entities surrounding each of the one or more non-semantic entities using a second prediction technique. In an embodiment, the second prediction technique may be trained based on second training data including a list of plurality of surrounding unigram semantic entities, bigrams semantic entities and trigram semantic entities corresponding to the plurality of pre-defined non-semantic entities. The processor may label each of the one or more non-semantic entities based on determination of the highest probability value from a sum of the first probability output and the second probability output for each of the plurality of labels.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a non-semantic entity extraction system, in accordance with an embodiment of the present disclosure.

FIG. 2 illustrates a functional block diagram of the entity extraction device, in accordance with various embodiments of the present disclosure.

FIG. 3A illustrates a table including an exemplary row entity data outputs extracted by the text detection/mining module, in accordance with the present disclosure.

FIG. 3B illustrates a table including exemplary split-row data text outputs, in accordance with the present disclosure.

FIG. 3C illustrates a table depicting various feature types and corresponding feature values for split-row entities, in accordance with an embodiment of the present disclosure.

FIG. 3D illustrates a table depicting output generated by the tokenization module, in accordance with an embodiment of the present disclosure.

FIG. 4 illustrates a table depicting training data for the second module, in accordance with some embodiments of the present disclosure.

FIG. 5 illustrates a table depicting exemplary outputs of the first model and the second model, in accordance with some embodiments of the present disclosure.

FIG. 6 illustrates a flowchart explaining the methodology of extracting non-semantic entities in a document image, in accordance with an embodiment of the present disclosure.

The illustrations presented herein are merely idealized and/or schematic representations that are employed to describe embodiments of the present invention.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

The method of extracting non-semantic entities from a document depends on the document image. Therefore, to identify and classify the non-semantic entities (including alphanumeric and numeric entities), certain rules are created to detect the presence of these non-semantic entities in the document text based on the document image.

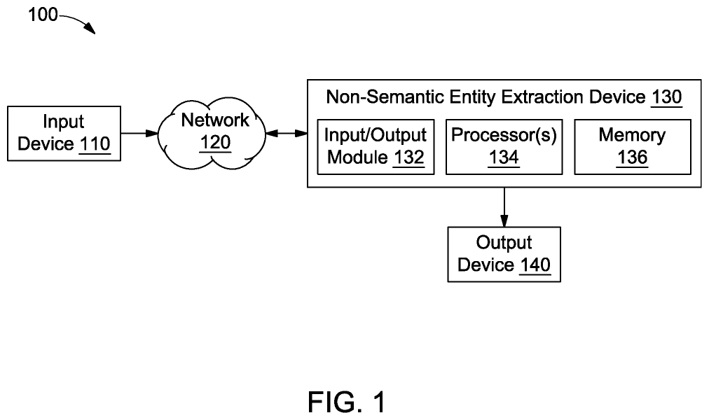

The present disclosure provides a method and a system for extracting non-semantic entities in a document image. Referring now to FIG. 1, a block diagram of a non-semantic entity extraction system 100 is illustrated, in accordance with an embodiment of the present disclosure. The non-semantic entity extraction system 100 includes an entity extraction device 130 comprising an input/output module 132, one or more processors 134, and a memory 136. The entity extraction device 130 may be communicably connected to an input device 110 through a network 120 and may directly be connected to an output device 140.

In an exemplary embodiment, the input device 110 may be enabled in a cloud or a physical database. In an embodiment, the input device 110 may be on a third-party paid server or an open-source database. The input device 110 may provide input data to entity extraction device 130 in a form, including but not limited to scanned document files such as PDF files, word documents, or any other suitable form, or images, printed paper records, or the like. Further, the input device 110 may provide the data files to the input/output module 132 which may be configured to receive and transmit information using one or more input and output interfaces respectively. The interface(s) may comprise a variety of interfaces, for example, interfaces for data input and output devices, referred to as I/O devices, storage devices, and the like. The interface(s) may facilitate communication of system 100 and may also provide a communication pathway for one or more components of the system 100.

In an embodiment, the entity extraction device 130 may be communicatively coupled to an output device 140 through a wireless or wired communication network 120. In an embodiment, the entity extraction device 130 may receive a request for text extraction from the output device 140 through network 120. In an embodiment, the output device 140 may be a variety of computing systems, including but not limited to, a smartphone, a laptop computer, a desktop computer, a notebook, a workstation, a portable computer, a personal digital assistant, a handheld, a mobile device, or the like.

The entity extraction device 130 may include one or more processor(s) 134 and a memory 136. In an embodiment, examples of processor(s) 134 may include but are not limited to, an Intel® Itanium® or Itanium 2 processor(s), or AMD® Opteron® or Athlon MP® processor(s), Motorola® lines of processors, FortiSOC™ system on a chip processors or other future processors. Processor 134, in accordance with the present disclosure, may be used for processing the document images or texts for non-semantic as well as semantic entity extraction process.

In an embodiment, memory 136 may be configured to store instructions that, when executed by processor 134, cause processor 134 to extract the non-semantic and semantic entities in a document image, as discussed in greater detail below. Memory 140 may be a non-volatile memory or a volatile memory. Examples of non-volatile memory may include but are not limited to, a flash memory, Read Only Memory (ROM), a Programmable ROM (PROM), Erasable PROM (EPROM), and Electrically EPROM (EEPROM) memory. Examples of volatile memory may include but are not limited to Dynamic Random Access Memory (DRAM), and Static Random-Access memory (SRAM).

In an embodiment, the communication network 120 may be a wired or a wireless network or a combination thereof. Network 120 may be implemented as one of the different types of networks, such as but not limited to, ethernet IP network, intranet, local area network (LAN), wide area network (WAN), the internet, Wi-Fi, LTE network, CDMA network, 4G, 5G, and the like. Further, network 120 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, network 120 can include a variety of network devices, including routers, bridges, servers, computing devices, storage devices, and the like.

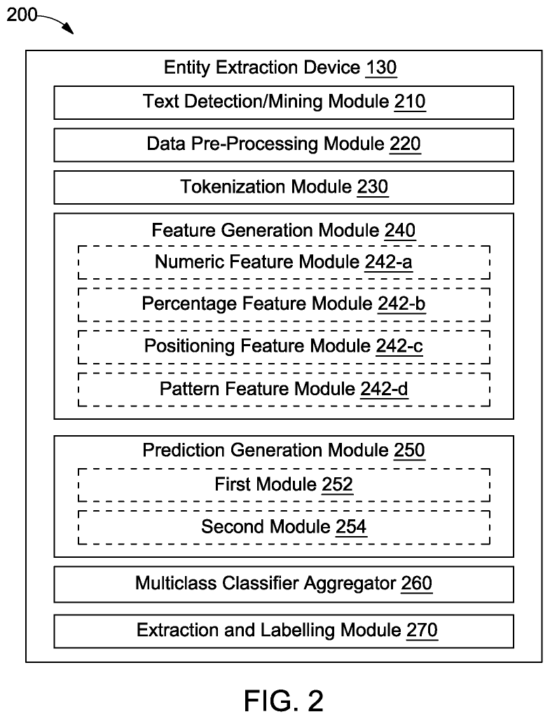

Referring now to FIG. 2, which illustrates a functional block diagram 200 of the entity extraction device 130, in accordance with an embodiment of the present disclosure. The entity extraction device 130 comprises a text detection/mining module 210, data pre-processing module 220, tokenization module 230, feature generation module 240, prediction generation module 250, multiclass classifier aggregator 260 and extraction and labelling module 270.

The various modules may be implemented as a combination of hardware and programming (for example, programmable instructions) to implement one or more functionalities of the modules. In examples described herein, such combinations of hardware and programming may be implemented in several different ways. For example, the programming for the modules may be processor-executable instructions stored on a non-transitory machine-readable storage medium and the hardware of the entity extraction device 130 which may comprise a processing resource (for example, one or more processors), to execute such instructions. In the present examples, the machine-readable storage medium may store instructions that, when executed by the processing resource, implement the modules. In such examples, the system 100 may comprise the machine-readable storage medium storing the instructions and the processing resource to execute the instructions, or the machine-readable storage medium may be separate but accessible to the system 100 and the processing resource. In other examples, the modules may be implemented by electronic circuitry.

In an embodiment, the feature generation module 240, may further include sub-modules including but not limited to numeric feature module 242-a, percentage feature module 242-b, positioning feature module 242-c, pattern feature module 242-d, and the like. The prediction generation module 250 may include one or more modules such as first module 252 and a second module 254.

The text detection/mining module 210 is configured to receive the input in form of image data from the input/output module 132. The image data may, include, but not limited to, a pdf file, a document image, a scanned image, a printable paper record, a passport document, an invoice document, a bank statement, a computerized receipt, a business card, a mail, a printout of any static-data, or any other suitable documentation thereof. The text detection/mining module 210 determines the textual information from the input image by converting the document image into the readable text image to determine text characters for each row of the document. In another scenario, the text detection/mining module 210 may receive input as pdf document and determine the textual information based on, but not limited to, pdf miner tool, etc. In an embodiment, the text detection/mining module 210 may use one or more text extraction techniques based on the input document format in order to extract text information. In an embodiment, the text extraction techniques may include, but not limited to, optical character recognition (OCR) technique, pdf miner technique, etc.

In an embodiment, the text detection/mining module 210 may utilize open-source image processing and/or Deep Learning based text detection methods for determining row entities in the document image. The obtained row entities may include textual information such as the text characters and their exact location or other information from the document image. The text detection/mining module 210 may create a list of row entities based on the text detected and their coordinate information and row location, etc.

In an embodiment, the textual information obtained from mining and OCR detection may include noise in form of undesired characters. To remove the noise, the data pre-processing module 220 may perform pre-processing of the data entities. The data pre-processing module 220 may trim whitespaces present between the text characters of the data entities and remove any punctuation characters present in the row entities. Further, the pre-processing of the row entities may include lowercasing the text case, removing stop words, performing lemmatization of the words in the row entities, or any other minor corrections thereof.

In an embodiment, the text detection/mining module 210 data entities may segregate the data entities into one or more row entities based on their corresponding row location. Further, each of the row entities may be split into one or more split-row entities for each of the rows using a pre-defined splitting rule. In an embodiment, the predefined splitting rule may include detection of one or more delimiter between the entities of the row entities such as, space, a hyphen, a comma, a back-slash, etc. In an exemplary embodiment, space, commas, etc. may be used as a delimiter to split the row entities into split-row entities.

Each of the split-row entities may include one or more alphabetic entities and one or more numeric entities. In an embodiment, the alphabetic entities may be determined based on detection of only alphabetic characters and the numeric entities may be determined based on detection of numeric characters only. The split-row entities may include one or more non-semantic entities and/or one or more semantic entities. The pre-processing module 220 may determine semantic entities from the alphabetic entities of the split-row entities using one or more semantic recognition techniques including but not limited to, parts of speech tagging, named entity recognition, sentiment analysis, topic modeling, and the like. For example, the named entity recognition technique is a submodule execution technique involving extracting information that seeks to locate and classify named entities mentioned in an unstructured text and converting them into pre-defined categories such as person names, organizations, locations, medical history, etc.

In an embodiment, the one or more non-semantic entities may be characterized based on presence of only numeric characters or any combination of numeric characters, special characters and/or alphabetic characters. In an embodiment, the split-row entities other than the semantic entities may be determined as the non-semantic entities based on determination of junk entities. In an embodiment the junk entities may be filtered based on, but not limited to, determination of at least four or more characters in each of the one or more split-row entities, determination of only alphabetical characters, and/or determination of a pre-defined format with respect to date, etc.

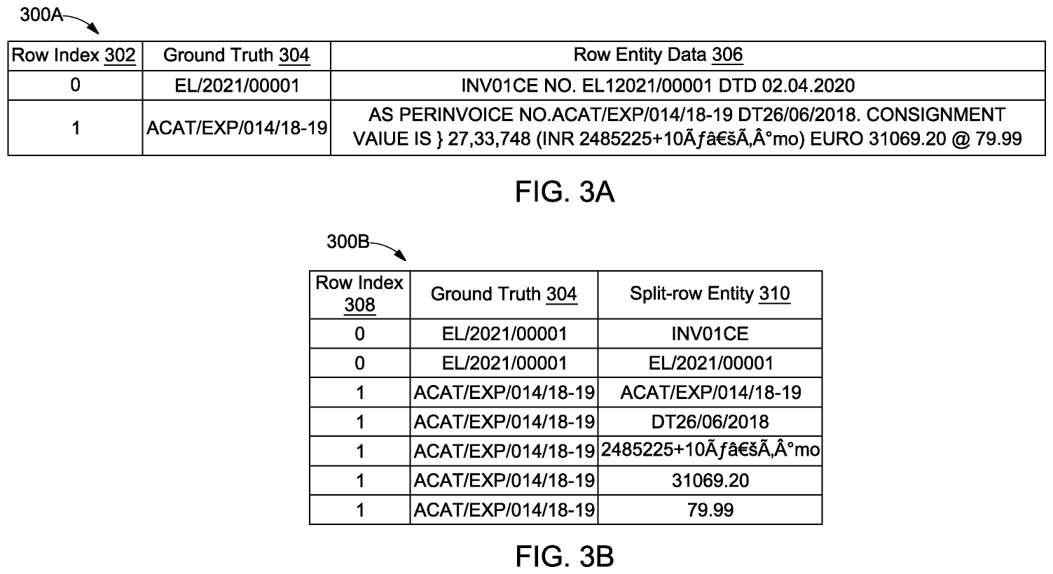

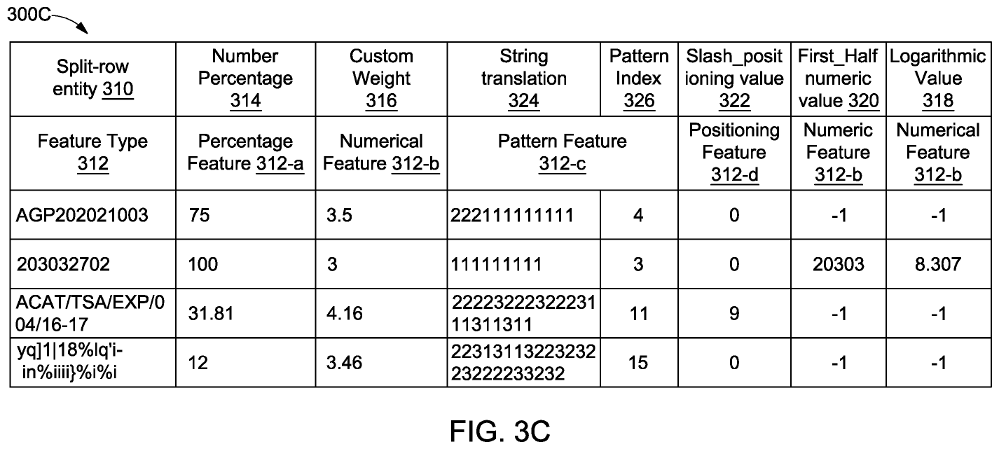

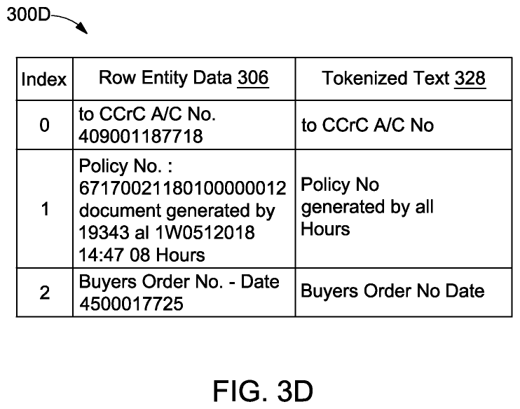

Referring now to FIG. 3A, a table 300A including an exemplary row entity data outputs extracted by the text detection/mining module 210 is illustrated, in accordance with the present disclosure. The table 300A depicts row entity data 306 determined from the input document for each row index 302 by the text detection/mining module 210. The ground truth 304 depicts the actual non-semantic data that is determined from the row entity data 306 based on manual interpretation.

Referring now to FIG. 3B, a table 300B including an exemplary split-row data text outputs is illustrated, in accordance with the present disclosure.

The row entity data 306 of FIG. 3A may be split into one or more split-row entities 310 in table 300B. The split-row entities 310 may include non-semantic entities and/or semantic entities. Further, each of the split-row entities 310 may be associated to a split index 308 based on the corresponding row index 302. Further, table 300B shows the ground truth values 304 of each split-row entity 310 which may be the non-semantic entity extracted for each row entity 306 based on manual interpretation.

By way of an example, for determining non-semantic entities from the row entity data 306, “INVOICE NO. EL12021/00001 DTD 02.04.2020”, for row index 302 “0”, the text detection/mining module 210 may determine split-row entities 310 as “INVOICE” and “EL12021/00001” based on detection of a delimiter or detection of four or more characters, or semantic entities or determination of entities of known format. In an embodiment, junk entities may be determined and removed from the row entities based on, but not limited to, determination of entities having less than four or more characters and/or determined as semantic entities, determination of only alphabetical characters, and/or determination of a pre-defined format with respect to date, etc.

Referring to FIG. 2, the feature generation module 240 may determine a plurality of feature values corresponding to each of a plurality of feature types, for each of the split-row entities 310 determined as the one or more non-semantic entities. In an embodiment, the feature generation module 240 may include a numeric feature module 242-a, a percentage feature module 242-b, a positioning feature module 242-c, and pattern feature module 242-d to respectively determine numeric features, percentage features, positioning features, and pattern features.

FIG. 3C illustrates a Table 300C depicting various feature types 312 and corresponding feature values for split-row entities 310, in accordance with an embodiment of the present disclosure. In an embodiment, the various feature types 312 as shown in Table 300C includes, but not limited to, percentage features 312-a, numeric features 312-b, pattern features 312-c, and positioning features 312-d.

In an embodiment, the percentage feature module 242-b may determine percentage features such as number percentage 314 which includes determining a percentage value of numeric characters in each split-row entity 310. In an embodiment, the percentage feature module 242-b may also determine alphabet percentage by determining a percentage value of alphabetic characters in each split-row entity 310. Further, the percentage feature module 242-b may also determine special character percentage by determining a percentage value of special characters in each of the split-row entities 310. In an exemplary embodiment, as shown in Table 300C, the percentage feature module 242-b may determine the number percentage values 312-a for each of the split-row entities 310 based on a percentage value of numeric characters present in each of the split-row entities 310.

In an embodiment, numeric feature module 242-a may determine one or more numerical features for each of the split-row entities 310. In an embodiment, the one or more numerical features determined may include, but not limited to, custom weight 316, logarithmic value, first-half numeric value, second-half numeric value, and the like. In an embodiment, the numeric feature module 242-a may determine the custom weight of the split-row entities 310 using the following equation:

$$custom weight = \frac{\begin{matrix}( ( no . of numbers ) * w 1 + ( no . of alphabets ) * \\ w 2 + ( no . of special charecters ) * w 3 )\end{matrix}}{3}$$

In an embodiment, the weights w1, w2, and w3 may be pre-defined based on experimental data.

For example, as shown in the table 300C, for the first row 310-a of the split-row entity 310, i.e. “AGP202021003” the custom weight 316 is calculated as “3.5” by using above equation for weights pre-defined as w1=1, w2-0.5 and w3=0.1. Similarly, in row 2 the custom weight for second row entity 310-b “203032702” which is a pure numeric text is calculated as “3” using the above equation.

In an embodiment, the numeric feature module 242-a may determine the logarithmic value of the split-row entity 310 comprising only numeric characters, else the logarithmic value for the split-row entity 310 may be determined as “−1” to depict that the split-row entity 310 does not include only numeric characters. For example, referring again to table 300C, the ‘logarithmic value’ 318 for split-row entity 310 of row 1, i.e. numeric text “203032702” is calculated as “8.307”, whereas for the rest of the split-row entity 310 having an alphanumeric text, the logarithmic value 318 is ‘−1’.

In an embodiment, the numeric feature module 242-a of FIG. 2 may determine the first-half numeric value and/or second-half numeric value of the split-row entities 310 based on the detection of only numeric characters in the split-row entities 310. In case the total number of numeric characters in the split-row entities 310 is determined to be an odd value, the number of characters in the first-half numeric value and/or second-half numeric value may be determined as half of the total number of numeric characters rounded to next integer value. In an embodiment, the split-row entities 310 do not have only numeric characters then the value of the first-half numeric value and/or second-half numeric value is assigned as ‘−1’. For example, in Table 300C of FIG. 3, the first-half numeric value 320 is determined for each split-row entity 310. The first-half numeric value 320 for first split-row entity 310-a, i.e. “ACAT/TSA/EXP/004/16-17”, is determined as ‘−1’, since the split-row entity 310 includes alphabetical, numeric and special characters. Further, the first-half numeric value 320 for the second split-row entity 310-b, i.e. numeric text “203032702” is calculated as “20303”.

In another embodiment, the feature generation module 240 of FIG. 2, includes positioning feature module 242-c to determine a plurality of positioning features of the split-row entities 310. The positioning feature module 242-c determines if special characters such as, slash, dot, hyphen, or a colon are present in the split-row entity 310 to respectively determine slash_positioning value, dot_positioning value, hyphen_positioning value, or a colon_positioning value. In order to determine the values of the positioning features, characters immediately next and before or surrounding the special character in the split-row entity 310 may be determined to be one of the only alphabetical characters, only numeric characters or an alphabetical and a numeric character. Accordingly, based on the determination of the surrounding character types from one of the only alphabetical characters, only numeric characters or an alphabetical and a numeric character a predefined constant value may be added to determine the positioning value for the corresponding special character. For example, in case an alphabetical and a numeric character surrounds the special character ‘1’ is added, in case only numeric characters surround the special character ‘2’ is added and in case only alphabetical characters surround the special character ‘3’ is added.

Accordingly, as shown in Table 300C, the slash_positioning value 322 for the third split-row entity 310-c, i.e. “ACAT/TSA/EXP/004/16-17”, is determined as ‘9’, since only alphabetical characters surround the first and second slash, an alphabetical and a numeric character surrounds the third slash and only numeric characters surround the fourth slash in “ACAT/TSA/EXP/004/16-17”. Accordingly, the slash_positioning value 322 may be determined as 3+3+1+2=9 for the third split-row entity 310-c, i.e. “ACAT/TSA/EXP/004/16-17”.

In another exemplary embodiment, the pattern feature module 242-d of FIG. 2, may determine one or more pattern features of the split-row entities. The pattern feature module 242-d enables character encoding to detect a string translation of each of the split-row entities 310. The string translation may be determined by representing a numeric character with ‘1’, an alphabetic character with ‘2’ and a special character with ‘3’ for the split-row entities 310. Further, the pattern feature module 242-d enables the determination translation index for each of the string translations based on the enumeration of various unique string translation patterns based on predefined indexes for already determined string translation patterns for the split-row entities 310. Accordingly, as shown in table 300C, the string translations value 324 for the second split-row entity 310-b, i.e. “203032702”, is determined as ‘111111111’, since only numerical characters are present, and the pattern index 326 is determined as ‘3’ based on a lookup of the string translation pattern ‘111111111’ with respect to predefined indexes (not shown). In an exemplary scenario, in case a string translation pattern 324 is determined for which there is no predefined index, then the pattern index 326 for such string translation pattern 324 may be represented with “−1”.

In an embodiment, the entity extraction device 130 may determine non-semantic entities from the split-row entities 310 based on the detection of four or more characters and detection of a plurality of numeric characters or a combination of a plurality of numeric characters, a plurality of special characters, and/or a plurality of alphabetic characters.

In another embodiment, the tokenization module 230 may determine one or more semantic entities surrounding the non-semantic entities for each row. The tokenization module 230 may determine the surrounding semantic entities based on a pre-defined list of most occurring unigram semantic entities, bigram semantic entities and trigram semantic entities determined surrounding one or more pre-defined non-semantic entities. In an embodiment, the pre-defined list of most occurring unigram semantic entities, bigram semantic entities and trigram semantic entities may be utilized to determine plurality of labels based on which the non-semantic entities may be labeled in order to associate them to some semantic logic based on the plurality of labels.

In an exemplary embodiment, the output generated by the tokenization module 230 is shown in FIG. 3D as table 300D, in accordance with an embodiment of the present disclosure. The table 300D of FIG. 3D illustrates the tokenized text 328 corresponding to the row-entity data 306 determined based on determination of semantic entities surrounding the non-semantic entities. In an embodiment, the surrounding semantic entities may be determined using one or more semantic recognition techniques including but not limited to, parts of speech tagging, named entity recognition, sentiment analysis, topic modeling, and the like for each row-entity 306 and/or the pre-defined list of most occurring unigram semantic entities, bigram semantic entities and trigram semantic entities determined surrounding one or more pre-defined non-semantic entities.

The prediction generation module 250 may include first module 252 and second module 254. The first module 252 may include one or more predictive machine learning algorithms such as but not limited to, Random Forest algorithm, which may be trained to based on training data corresponding to a plurality of non-semantic entities labeled based on the plurality of labels and corresponding plurality of feature values determined for a predefined plurality of non-semantic entities. In an embodiment, an exemplary list of labels determined based on training data may include the following labels: PO Number, Account Number, COO Number, Reference Number, Remittance number, Shipping Bill Number, AWB Number, No Label. Accordingly, the first module 252 may provide a first array of probabilities for each of the plurality of labels for each non-semantic entities in each row entity 306 based on the feature values of its corresponding split-row entities that are determined as non-semantic entities. Based on the first array of probabilities a first label may be predicted for each of the non-semantic entities of each row-entity entity 310. According to the exemplary embodiment, the first array of probabilities may include “8” probability values for each of the following labels: PO Number, Account Number, COO Number, Reference Number, Remittance number, Shipping Bill Number, AWB Number, No Label.

Further, the second module 254 may include one or more predictive machine learning algorithms such as but not limited to, Random Forest algorithm, which may be trained to based on a list of labels and corresponding to the predefined list of most occurring unigram semantic entities, bigram semantic entities and trigram semantic entities for each of the plurality of labels.

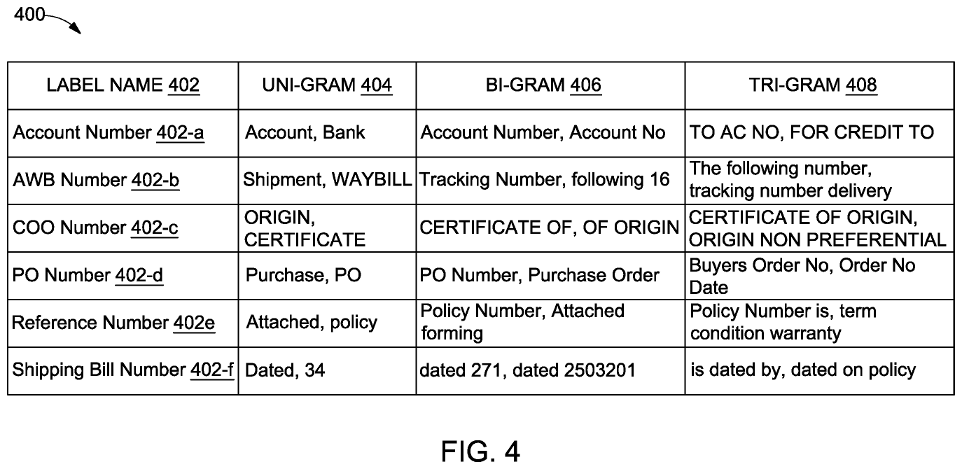

FIG. 4 illustrates a table 400 depicting training data for second module, in accordance with an embodiment of the present disclosure. The table 400 provides a list of labels depicted by label name 402 and corresponding unigram semantic entities 404, bigram semantic entities 406 and trigram semantic entities 408 for each labels 402-a-f.

Accordingly, the second module 254 may output a second array of probabilities for each of the plurality of labels based on the detection of semantic entities in each row entity 306 based on the training data as shown in table 400. Based on the second array of probabilities a second label may be predicted for each of the non-semantic entities of each row-entity entity 310. According to the exemplary embodiment, the second array of probabilities may include “8” probability values for each of the following labels: PO Number, Account Number, COO Number, Reference Number, Remittance number, Shipping Bill Number, AWB Number, No Label.

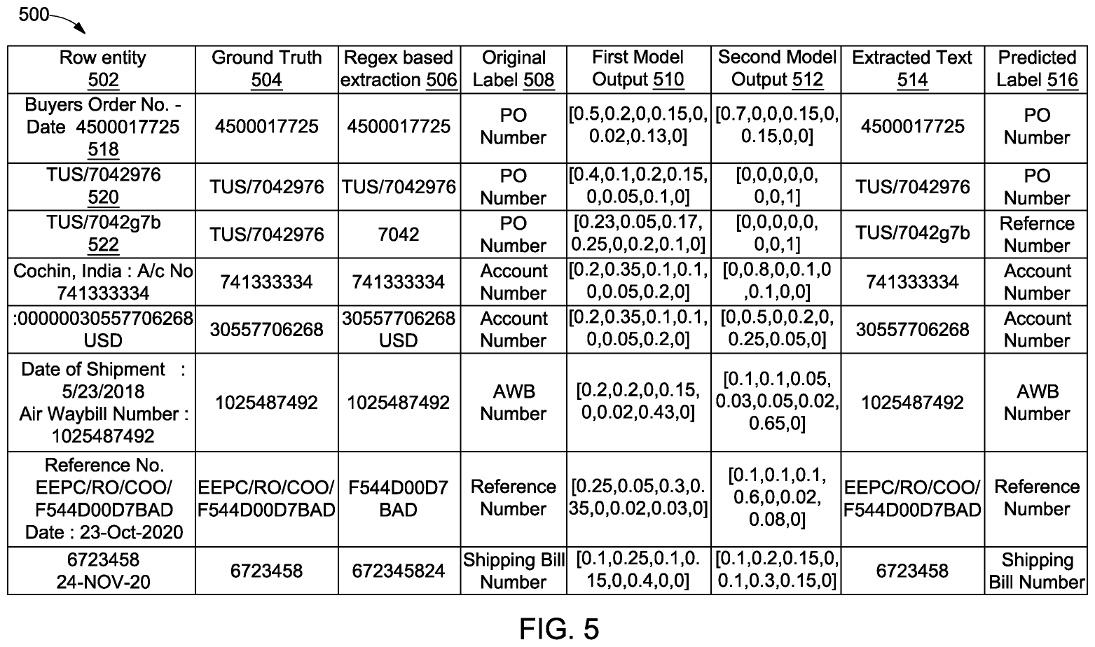

In an exemplary embodiment, the outputs of the first model 252 and the second model 254 may be provided to the multiclass classifier aggregator 260. FIG. 5 illustrates a table 500 depicting exemplary outputs of the first model 252 and the second model 254, in accordance with an embodiment of the present disclosure. For example, as shown in table 500, of FIG. 5, the first module output 510 and the second module output 512 may depict array of probabilities for each of the plurality of labels for each of the row entities 502. Further, table 500 provides ground truth values 504, regex-based extraction output 506, original label 508, extracted text 514 and predicted label 516 for each of the row entities 502. For example, as shown in table 500, of FIG. 5, the first row entity 518, provides that as per first model output 210 there is a 50% chance that the non-semantic entity of the row entity 502 of the first row 518 will correspond to label “PO number”, and 20% chance of correspondence to label “account number”, and the like. Therefore, the first module output 510 is an array of probabilities for each of the plurality of labels: PO Number, Account Number, COO Number, Reference Number, Remittance number, Shipping Bill Number, AWB Number, No Label. In an embodiment, “no label” is predicted in case the row entity 502 does not correspond to any of the pre-defined plurality of labels.

Further, the second module output 512 depicts an array of probabilities for each of the plurality of labels for each of the row entities 502 determined based on surrounding semantic entity determination around the non-semantic entity for each of the row entities 502. Since the row entities 502 which is fed to the prediction generation module 240 which may contain one or more non-semantic entities and/or the semantic entities, therefore, using the surrounding semantic entities around the non-semantic entity, the second model output 254 is generated depicting probabilities for each of the plurality of labels for each of the row entities 502 based on the correspondence of the surrounding semantic entities to each of the plurality of labels. For example, as shown in table 500, of FIG. 5, in first row 518 of the row entity 502, shows that as per second model output 512 there is a 70% chance that the non-semantic entity of the first row entity 518 will correspond to the label of “PO number” based on surrounding semantic entities of the non-semantic entities of the first row 518. Further, the second module output 512 for the first row entity 518 provides that there in 15% chance of correspondence to label “Reference Number”, and so on. In an embodiment, in case there is no semantic entity present or determined surrounding the non-semantic entity of the row entities 502 the output of the second model 512 is depicted as 100% probability for label “No label”.

In an exemplary embodiment, second module output 512 of second row 520 as shown in table 500, of FIG. 5 for row entity 520 “TUS/7042976”, which is determined to be a non-semantic entity based on determination of more than 4 characters and a presence of a combination of a plurality of text characters, alphabetic characters and/or special characters the extracted row entity text. Further, it may be seen that there is no surrounding semantic text present in the second row entity 520 of the table 500. Therefore, the second module output 512 for the second row entity 520 may generate a zero probability score for almost all of the labels with only 100% chance of label being identified as a “No Label”.

In an embodiment, referring now to FIG. 2, the outputs of the first module 252 and the second module 254 are inputted to the multiclass classifier aggregator 260. The multiclass classifier aggregator 260 is configured to determine a final label to classify each of the non-semantic entity of the row-entities 306 based on a sum of the outputted probabilities from the first module 252 and the second module 254 for each of the split-row entity 310 determined as a non-semantic entity. In an embodiment, in case the output of second module 254 is “No Label” or undetermined, based on the non-presence of surrounding semantic entities, the first model output 510 may only be utilized by the multiclass classifier aggregator 260 to determine the final labels or predicted labels. The label corresponding to the highest probability from the sum of the outputted probabilities from the first module 252 and the second module 254 is selected as the final label or predicted label for the non-semantic entity of each row entity 310. In an embodiment, the multiclass classifier aggregator 260 may include various classification models, and may utilize machine learning models such as, but not limited to, Random Forest Classifier, etc.

Referring now to FIG. 5, table 500 depicts the first module output 510 and the second module output 512 for each row entity 502. The predicted label 516 for each row entity is determined based on the sum of arrays of probabilities for each of the plurality of labels of the first module output 252 and the second module output 254. In the table 500, the sum of probability for first-row entity 518 is highest for the label “PO Number” which is outputted as the predicted label. For the second row entity 520, the sum of probabilities is highest for the label “PO Number” as the second module output 512 is “No Label”.

In an embodiment, referring now to FIG. 2, the extraction and labeling module 270 may extract the non-semantic entities for each row entity 306 based on the features determined for each of the corresponding split-row entity 310. Further, each of the extracted non-semantic entities may be labeled based on the final label outputted by the multiclass classifier aggregator 260.

Referring now to FIG. 5, table 500 provides ground truth 504 for each of the row entities 502 which are deduced by manual interpretation. Further, the table 500 provides regex-based extraction 506 for each of the row entities 502 and original label 508 which are outputted from a model based on “Regular Expression” techniques. Table 500 depicts that the second module output 512 for the third row entity 522, is “No Label” and the ground truth 504 value is “TUS/7042976” which is different from Regex-based extraction 506 value i.e. “7042”. Further, it can be seen that the extracted text 514 for third row entity 522 is “TUS/7042976” which is the same as the ground truth 504. Accordingly, it is shown that the methodology of the present disclosure is as accurate as the ground truth value 504.

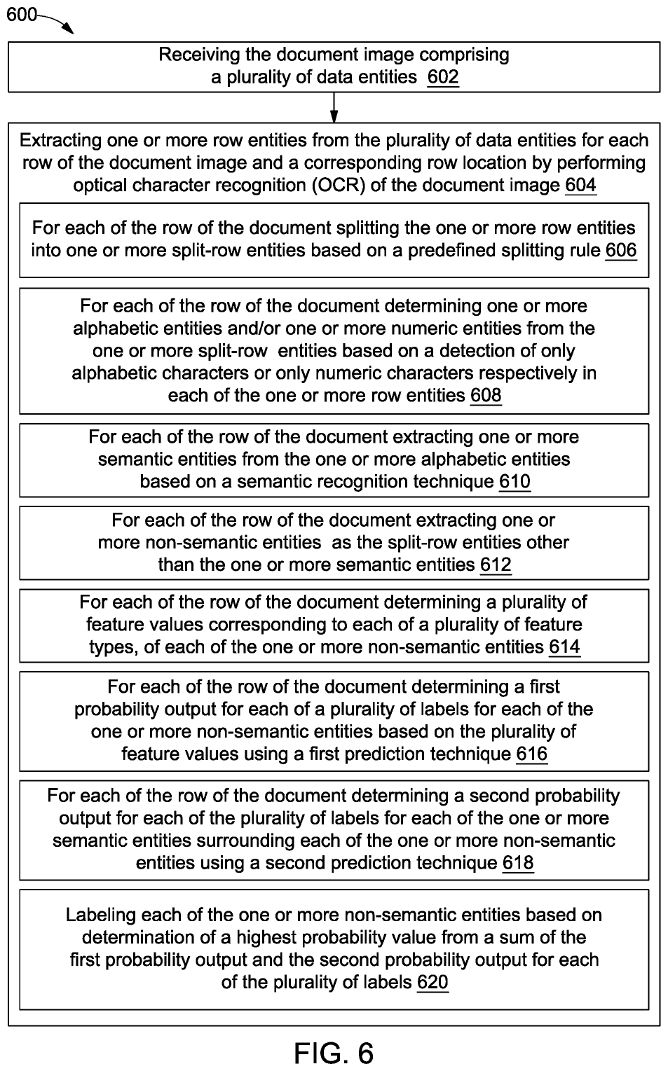

Referring now to FIG. 6 is a flowchart depicting the methodology of extraction of one or more non-semantic entities in a document image, in accordance with an embodiment of the present disclosure. At step 602, a document image comprising a plurality of data entities is received. At step 604, one or more row entities 306 from the plurality of data entities for each row of the document image is extracted and a corresponding row location or index 302 is determined based on a text extraction technique from the document image. In an embodiment, the one or more row entities 306 may include one or more non-semantic entities and/or one or more semantic entities. In an embodiment, the one or more non-semantic entities may include a plurality of numeric characters or a combination of a plurality of numeric characters, a plurality of special characters, and a plurality of alphabetic characters. At step 606, for each row 302 of the document, the one or more row entities 306 is split into one or more split-row entities 310 based on a predefined splitting rule. At step 608, for each of the row 302, one or more alphabetic entities and/or one or more numeric entities from the one or more split-row entities are determined based on detection of only alphabetic characters or only numeric characters respectively in each of the one or more row entities. At step 610, for each row of the document, one or more semantic entities may be extracted from the one or more alphabetic entities based on a semantic recognition technique. At step 612, for each row of the document, one or more non-semantic entities may be extracted from the split-row entities other than the one or more semantic entities. At step 614, for each row of the document, a plurality of feature values corresponding to each of a plurality of feature types, for each of the one or more non-semantic entities may be determined. At step 616, for each of the row of the document, a first label from a plurality of labels may be determined for each of the one or more non-semantic entities based on the plurality of feature values of each of the one or more non-semantic entities using a first prediction technique. In an embodiment, the first prediction technique may be trained based on first training data corresponding to a plurality of non-semantic entities labeled based on the plurality of labels and corresponding plurality of feature values. At step 618, for each row of the document, a second label from the plurality of labels for each of the one or more semantic entities surrounding each of the one or more non-semantic entities using a second prediction technique may be determined. In an embodiment, the second prediction technique is trained based on second training data comprising a list of plurality of surrounding unigram semantic entities, bigrams semantic entities and trigram semantic entities corresponding to the plurality of pre-defined non-semantic entities. At step 620, labels of each of the one or more non-semantic entities may be determined based on the first label or the second label based on the determination of the highest probability value from a sum of corresponding probability outputs generated by the first prediction technique and the second prediction technique for each of the plurality of labels.

It is intended that the disclosure and examples be considered as exemplary only, with a true scope of disclosed embodiments being indicated by the following claims.

What is claimed is:

1. A method of extracting one or more non-semantic entities in a document image, the method comprising:
receiving, by a processor, the document image comprising a plurality of data entities;
extracting, by the processor, one or more row entities from the plurality of data entities for each row of the document image and a corresponding row location based on a text extraction technique from the document image, wherein the one or more row entities comprises the one or more non-semantic entities and/or one or more semantic entities, wherein the one or more non-semantic entities comprises a plurality of numeric characters or a combination of a plurality of numeric characters, a plurality of special characters, and a plurality of alphabetic characters;
for each of the row of the document:
splitting, by the processor, the one or more row entities into one or more split-row entities based on a predefined splitting rule;
determining, by the processor, one or more alphabetic entities and/or one or more numeric entities from the one or more split-row entities based on a detection of only alphabetic characters or only numeric characters respectively in each of the one or more row entities;
extracting, by the processor, one or more semantic entities from the one or more alphabetic entities based on a semantic recognition technique;
extracting, by the processor, one or more non-semantic entities as the split-row entities other than the one or more semantic entities;
determining, by the processor, a plurality of feature values corresponding to each of a plurality of feature types, for each of the one or more non-semantic entities;
determining, by the processor, a first probability output for each of a plurality of labels for each of the one or more non-semantic entities based on the plurality of feature values using a first prediction technique, wherein the first prediction technique is trained based on first training data corresponding to a plurality of predefined non-semantic entities labeled based on the plurality of labels and corresponding plurality of feature values;
determining, by the processor, a second probability output for each of the plurality of labels for each of the one or more semantic entities surrounding each of the one or more non-semantic entities using a second prediction technique, wherein the second prediction technique is trained based on second training data comprising a list of plurality of surrounding unigram semantic entities, bigrams semantic entities and trigram semantic entities corresponding to the plurality of pre-defined non-semantic entities; and
labeling, by the processor, each of the one or more non-semantic entities based on determination of a highest probability value from a sum of the first probability output and the second probability output for each of the plurality of labels.

2. The method of claim 1, wherein each of the one or more non-semantic entities are determined based on determination of at least four or more characters in each of the one or more split-row entities, and
wherein the predefined splitting rule is based on detection of one or more delimiter.

3. The method of claim 1, comprises preprocessing the one or more row entities by:
trimming, by the processor, one or more white spaces between the one or more row entities;
removing, by the processor, one or more punctuation characters in each of one or more row entities;
converting, by the processor, each alphabetic character of the one or more row entities into a lower case alphabetic character;
removing, by the processor, one or more stop words from the one or more row entities; and
lemmatizing, by the processor, the one or more row entities.

4. The method of claim 1, wherein the plurality of feature types comprises: one or more numeric features, one or more percentage features, one or more positioning features, one or more and one or more pattern features.

5. The method of claim 4, wherein the determination of the plurality of feature values corresponding to the one or more numeric features comprises:
determining, by the processor, a custom weight for each of the one or more non-semantic entities based on a number of alphabetic characters, a number of numeric characters and a number of special characters;
determining, by the processor, a plurality of consecutive numeric characters present in a first half or a second half of each of the one or more non-semantic entities; and
determining, by the processor, a logarithmic value of each of the numeric entities.

6. The method of claim 4, wherein the determination of the plurality of feature values corresponding to the percentage features comprises:
determining, by the processor, a percentage value of numeric characters, a percentage value of alphabetic characters, and a percentage value of special characters in each of the non-semantic data.

7. The method of claim 4, wherein the determination of the plurality of feature values corresponding to the positioning features comprises:
determining, by the processor, a position of one or more special characters in each of the non-semantic entities with respect to surrounding characters to the one or more special characters in each of the non-semantic entities.

8. The method of claim 4, wherein the determination of the plurality of feature values corresponding to the pattern features comprises:
determining, by the processor, a pattern for each of the one or more non-semantic entities based on a presence of a numerical character, an alphabetical character, or a special character.

9. The method of claim 1, wherein the plurality of labels are determined based on the list of plurality of surrounding unigram semantic entities, bigram semantic entities and trigram semantic entities corresponding to the plurality of predefined non-semantic entities.

10. A system for extracting one or more non-semantic entities in a document image, comprising:
one or more processors;
a memory communicatively coupled to the processors, wherein the memory stores a plurality of processor-executable instructions, which, upon execution, cause the processors to:
extract one or more row entities from a plurality of data entities for each row of the document image and a corresponding row location based on a text extraction technique from the document image, wherein the one or more row entities comprises the one or more non-semantic entities and/or one or more semantic entities, wherein the one or more non-semantic entities comprises a plurality of numeric characters or a combination of a plurality of numeric characters, a plurality of special characters, and a plurality of alphabetic characters;
for each of the row of the document, causing the processors to:
split the one or more row entities into one or more split-row entities based on a predefined splitting rule;
determine one or more alphabetic entities and/or one or more numeric entities from the one or more split-row entities based on a detection of only alphabetic characters or only numeric characters respectively in each of the one or more row entities;
extract one or more semantic entities from the one or more alphabetic entities based on a semantic recognition technique;
extract one or more non-semantic entities as the split-row entities other than the one or more semantic entities;
determine a plurality of feature values corresponding to each of a plurality of feature types, for each of the one or more non-semantic entities;
determine a first probability output for each of a plurality of labels for each of the one or more non-semantic entities based on the plurality of feature values using a first prediction technique, wherein the first prediction technique is trained based on first training data corresponding to a plurality of predefined non-semantic entities labeled based on the plurality of labels and corresponding plurality of feature values;
determine a second probability output for each of the plurality of labels for each of the one or more semantic entities surrounding each of the one or more non-semantic entities using a second prediction technique, wherein the second prediction technique is trained based on second training data comprising a list of plurality of surrounding unigram semantic entities, bigrams semantic entities and trigram semantic entities corresponding to the plurality of pre-defined non-semantic entities; and
label each of the one or more non-semantic entities based on determination of a highest probability value from a sum of the first probability output and the second probability output for each of the plurality of labels.

11. The system of claim 10, wherein the plurality of feature types comprises: one or more numeric features, one or more percentage features, one or more positioning features, and one or more pattern features.

12. The system of claim 11, wherein the one or more numeric features are determined based on:
determination of a custom weight for each of the one or more non-semantic entities based on several alphabetic characters, a number of numeric characters and a number of special characters;
determination of a plurality of consecutive numeric characters present in a first half or a second half of each of the one or more non-semantic entities; and
determining a logarithmic value of each of the numeric entities.

13. The system of claim 11, wherein the one or more percentage features are determined based on:
determination of a percentage value of numeric characters, a percentage value of alphabetic characters, and a percentage value of special characters in each of the non-semantic data.

14. The system of claim 11, wherein the one or more position features are determined based on:
determination of a position of one or more special characters in each of the non-semantic entities with respect to surrounding characters to the one or more special characters in each of the non-semantic entities.

15. The system of claim 11, wherein the one or more pattern features are determined based on:
determination of a pattern for each of the one or more non-semantic entities based on a presence of a numerical character, an alphabetical character, or a special character.

16. A non-transitory computer-readable medium storing computer-executable instructions for extracting one or more non-semantic entities in a document image, the computer-executable instructions configured for:
receiving the document image comprising a plurality of data entities;
extracting one or more row entities from the plurality of data entities for each row of the document image and a corresponding row location based on a text extraction technique from the document image, wherein the one or more row entities comprises the one or more non-semantic entities and/or one or more semantic entities, wherein the one or more non-semantic entities comprises a plurality of numeric characters or a combination of a plurality of numeric characters, a plurality of special characters, and a plurality of alphabetic characters;
for each of the row of the document:
splitting the one or more row entities into one or more split-row entities based on a predefined splitting rule;
determining one or more alphabetic entities and/or one or more numeric entities from the one or more split-row entities based on a detection of only alphabetic characters or only numeric characters respectively in each of the one or more row entities;
extracting one or more semantic entities from the one or more alphabetic entities based on a semantic recognition technique;
extracting one or more non-semantic entities as the split-row entities other than the one or more semantic entities;
determining a plurality of feature values corresponding to each of a plurality of feature types, for each of the one or more non-semantic entities;
determining a first probability output for each of a plurality of labels for each of the one or more non-semantic entities based on the plurality of feature values using a first prediction technique, wherein the first prediction technique is trained based on first training data corresponding to a plurality of predefined non-semantic entities labeled based on the plurality of labels and corresponding plurality of feature values;
determining a second probability output for each of the plurality of labels for each of the one or more semantic entities surrounding each of the one or more non-semantic entities using a second prediction technique, wherein the second prediction technique is trained based on second training data comprising a list of plurality of surrounding unigram semantic entities, bigrams semantic entities and trigram semantic entities corresponding to the plurality of pre-defined non-semantic entities; and
labeling each of the one or more non-semantic entities based on determination of a highest probability value from a sum of the first probability output and the second probability output for each of the plurality of labels.

17. The non-transitory computer-readable medium of claim 16, wherein each of the one or more non-semantic entities are determined based on determination of at least four or more characters in each of the one or more split-row entities, and
wherein the predefined splitting rule is based on detection of one or more delimiter.

18. The non-transitory computer-readable medium of claim 16, the computer-executable instructions are configured to preprocess the one or more row entities by:
trimming one or more white spaces between the one or more row entities;
removing one or more punctuation characters in each of one or more row entities;
converting each alphabetic character of the one or more row entities into a lower case alphabetic character;
removing one or more stop words from the one or more row entities; and
lemmatizing the one or more row entities.

19. The non-transitory computer-readable medium of claim 16, wherein the plurality of feature types comprises: one or more numeric features, one or more percentage features, one or more positioning features, one or more and one or more pattern features.

20. The non-transitory computer-readable medium of claim 19, wherein the determination of the plurality of feature values corresponding to the one or more numeric features comprises:
determining a custom weight for each of the one or more non-semantic entities based on a number of alphabetic characters, a number of numeric characters and a number of special characters;
determining a plurality of consecutive numeric characters present in a first half or a second half of each of the one or more non-semantic entities; and
determining a logarithmic value of each of the numeric entities.
